(19) United States
(12) Patent Application Publication
(10) Pub. No.: US 2007/0047647 A1
(43) Pub. Date: Mar. 1, 2007

(54) Apparatus and method for enhancing image using motion estimation

(75) Inventors: Ki-deok Lee, Seoul (KR); Seung-joon Yang, Seoul (KR); Young-ho Lee, Yongin-si (KR); Hak-hun Choi, Gumi-si (KR); Hyung-jin Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/507,468

(22) Filed: Aug. 22, 2006

(30) Foreign Application Priority Data
Aug. 24, 2005 (KR) 2005-0078029

(51) Int. Cl. H04N 7/12; H04B 1/66

(52) U.S. Cl. 375/240.12; 375/240.29

(57) ABSTRACT

An image enhancement apparatus using motion estimation includes: a motion estimation unit estimating a degree of motion between an input image on which image enhancement is performed and a temporally successive image; and an enhancement unit applying the image enhancement to an area without motion in the input image while not applying the image enhancement to an area with motion in the input image on the basis of the motion degree. Accordingly, by performing image enhancement on an area without motion in an input image while not performing image enhancement on an area with motion in the input image, it is possible to prevent image noise from being generated in the area with motion.

This application claims priority from Korean Patent Application No. 10-2005-0078029, filed on Aug. 24, 2005, the entire content of which is incorporated herein by reference.

### BACKGROUND OF THE INVENTION

1. Field of the Invention

Apparatuses and methods consistent with the present invention relate to enhancing an image using motion estimation, and more particularly, to adaptively applying an image enhancement level according to an image motion degree calculated by motion estimation.

2. Description of the Related Art

Image enhancement technologies are used to emphasize details of an image for the purpose of improving the actual clearness of the image, object identification, and to reduce noise or prevent noise from being amplified.

FIGS. 1A and 1B are views for explaining a conventional image enhancement method. FIG. 1A is a block diagram of a conventional image detail enhancement apparatus. FIG. 1B shows waveforms output from respective blocks included in the conventional image detail enhancement apparatus illustrated in FIG. 1A.

Referring to FIGS. 1A and 1B, the conventional image detail enhancement apparatus includes a first differentiator 10, a second differentiator 20, a full-wave rectifier 30, a limiting amplifier 40, a four-quadrant multiplier 50, an adder 70, and a delayer 60.

When an image signal with a waveform A illustrated in FIG. 1B is received, the first differentiator 10 differentiates the image signal and outputs an image signal with a waveform B to the second differentiator 20 and the rectifier 30.

The second differentiator 20 differentiates the image signal with the waveform B received from the first differentiator 10 and outputs an image signal with a waveform C. The full-wave rectifier 30 rectifies the image signal with the waveform B received from the first differentiator 10 and outputs an image signal with a waveform E.

The limiting amplifier 40 receives the image signal with the waveform C from the second differentiator 20, limits the secondary differentiated value C to a predetermined range, and outputs an image signal with a waveform D.

The four-quadrant multiplier 50 multiplies an inverted signal of the image signal with the waveform D by the image signal with the waveform E output from the full-wave rectifier 30, and outputs an image signal with a waveform F.

The delayer 60 delays the image signal with the waveform A, and the adder 70 adds the delayed signal with the image signal with the waveform F output from the four-quadrant multiplier 50, and outputs an image signal with a waveform G.

As illustrated in FIG. 1B, comparing the image signal A with the enhanced image signal G output from the adder 70, it can be seen that details of an image are emphasized.

However, the conventional image enhancement apparatus enhances details of an image and performs signal processing using a primary differentiator filter and a secondary differentiator filter, not considering the motion of the image. In a case of an image with motion, picture quality deteriorates, since detail enhancement is also performed on noise caused by the motion.

Accordingly, it is desirable to minimize deterioration in picture quality by using temporal information such as motion information to enhance details of an image when outlines and details of an image are enhanced on the basis of spatial information.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image enhancement apparatus and method using motion estimation, which are capable of improving picture quality by using temporal information such as motion information as well as spatial information, when image enhancement is performed.

In accordance with an aspect of the present invention, there is provided an image enhancement apparatus using motion estimation including: a motion estimation unit estimating a degree of motion between an input image on which image enhancement is performed and a temporally successive image; and an enhancement unit applying the image enhancement to an area without motion in the input image while not applying the image enhancement to an area with motion in the input image, on the basis of the degree of motion.

Preferably, but not necessarily, the enhancement unit includes: a high-pass filter performing high-pass filtering on the input image; a first multiplier multiplying the input image subjected to high-pass filtering by a value resulting from subtracting the degree of motion from ‘1’; a second multiplier multiplying the input image by the degree of motion; and a first adder summing the multiplied result received from the first multiplier with the multiplied result received from the second multiplier.

The image enhancement apparatus further includes: a filtering unit smoothing the input image before the image enhancement is performed.

The filtering unit smoothes the area with motion in the input image, and does not smooth the area without motion in the input image, on the basis of the degree of motion.

Preferably, but not necessarily, the filtering unit includes: a low-pass filter performing low-pass filtering on the input image; a third multiplier multiplying the input image subjected to low-pass filtering by the motion degree; a fourth multiplier multiplying the input image by a value resulting from subtracting the degree of motion from ‘1’; and a second adder summing the multiplied result received from the third multiplier with the multiplied result received from the fourth multiplier.

In accordance with another aspect of the present invention, there is provided an image enhancement method including: estimating a degree of motion between an input image on which image enhancement is performed and a temporally successive image; and applying the image enhancement to an area without motion in the input image while not applying the image enhancement to an area with motion in the input image, on the basis of the degree of motion.

Preferably, but not necessarily, the applying of the image enhancement includes: performing high-pass filtering on the input image; multiplying the input image subjected to high-pass filtering by a value resulting from subtracting the degree of motion from ‘1’, thus obtaining a first output value; multiplying the input image by the degree of motion, thus obtaining a second output value; and summing the first output value with the second output value.

Preferably, the image enhancement method further includes performing smoothing on the input image to remove noise of the input image, before the image enhancement is performed.

In the removing of the noise, the smoothing is performed on the area with motion in the input image and the smoothing is not performed on the area without motion in the input image, on the basis of the motion degree.

Preferably, but not necessarily, the removing of the noise includes: performing low-pass filtering on the input image; multiplying the input image subjected to low-pass filtering by the degree of motion, thus obtaining a third output value; multiplying the input image by a value resulting from subtracting the degree of motion from ‘1’, thus obtaining a fourth output value; and summing the third output value with the fourth output value.

### BRIEF DESCRIPTION OF THE DRAWINGS

The above and/or other aspects of the present invention will be more apparent by describing certain exemplary embodiments of the present invention with reference to the accompanying drawings, in which:

FIGS. 1A and 1B are views for explaining a conventional image enhancement method;

FIG. 2 is a block diagram of an image enhancement apparatus using motion estimation according to an exemplary embodiment of the present invention;

FIGS. 3A through 3D are views for explaining an enhancement unit illustrated in FIG. 2;

FIGS. 4A and 4B respectively illustrate a motion adaptive enhancement unit and a motion adaptive filtering unit illustrated in FIGS. 3A through 3D; and

FIG. 5 is a flowchart illustrating an image enhancement method using motion estimation according to an exemplary embodiment of the present invention.

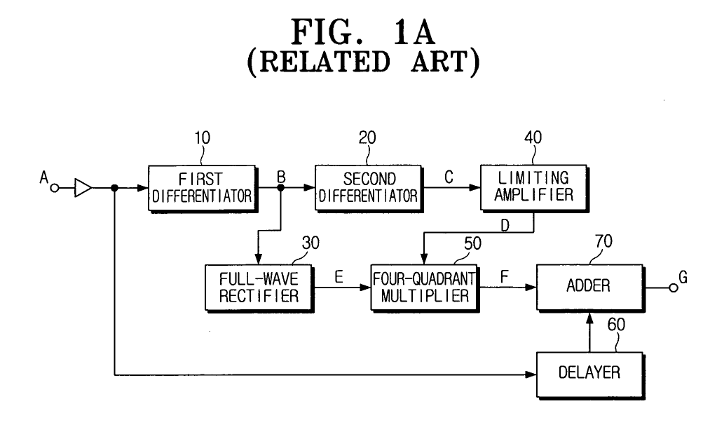

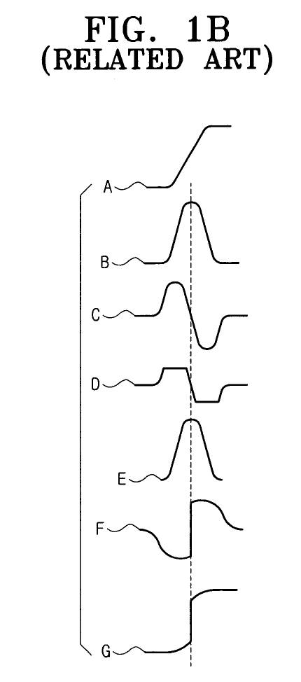

### DETAILED DESCRIPTION OF THE EXEMPLARY EMBODIMENTS

Certain exemplary embodiments of the present invention will be described in greater detail with reference to the accompanying drawings.

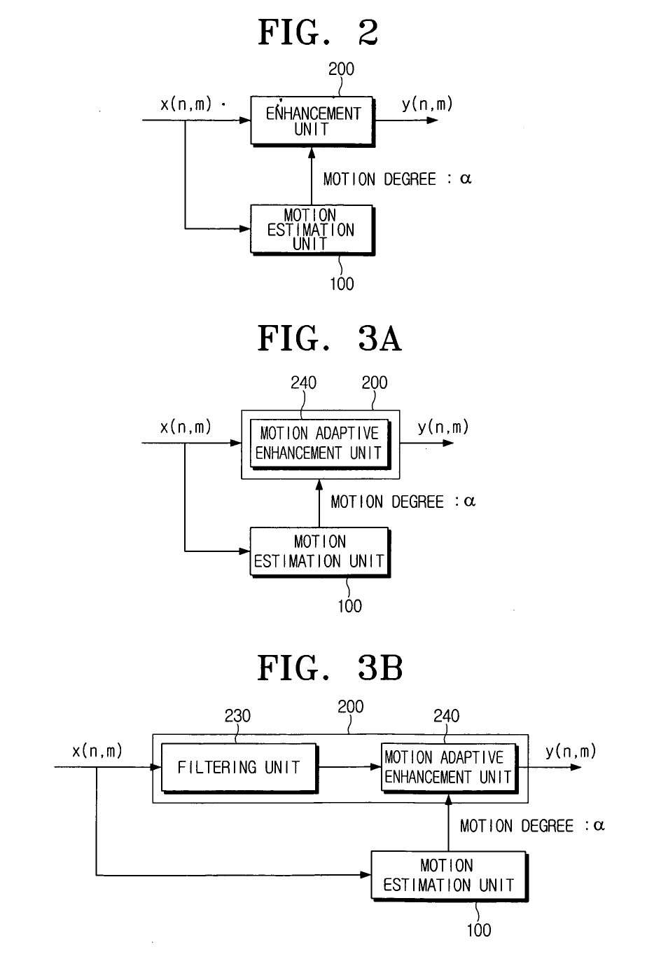

FIG. 2 is a block diagram of an image enhancement apparatus using motion estimation according to an exemplary embodiment of the present invention.

Referring to FIG. 2, the image enhancement apparatus using motion estimation includes a motion estimation unit 100 and an enhancement unit 200.

The motion estimation unit 100 estimates the most similar block between an image whose detail, clearness, etc. will be improved and a temporally successive image, and detects a degree of motion, using temporally successively received images. A motion estimation value which represents the degree of motion is an arbitrary value between ‘0’ and ‘1’.

The enhancement unit 200 adaptively applies an image enhancement level to the image according to the degree of motion estimated by the motion estimation unit 100.

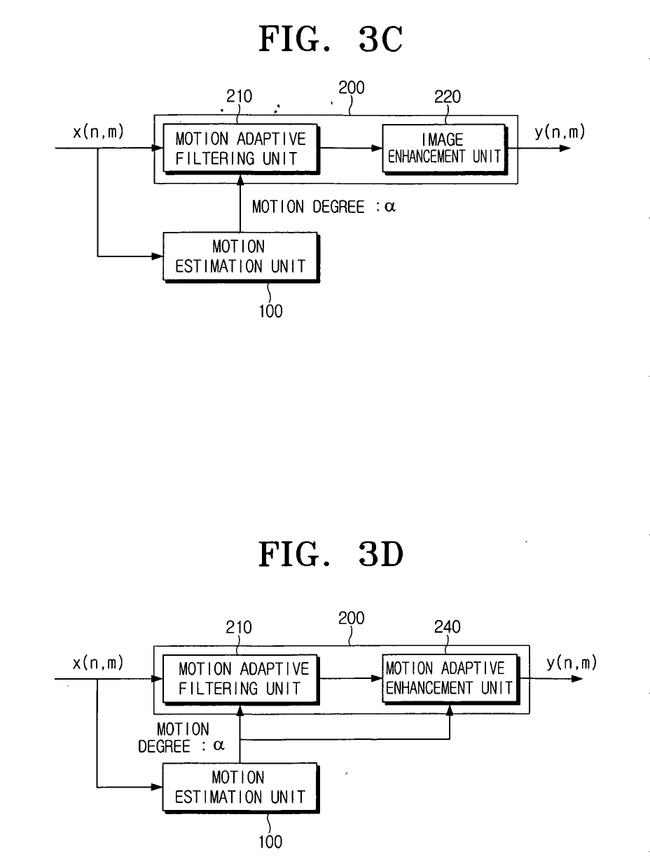

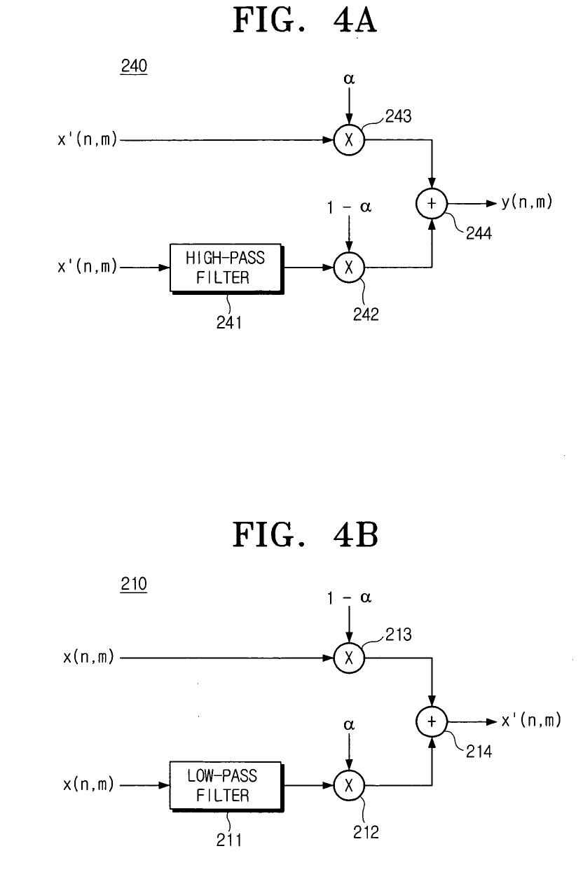

FIGS. 3A through 3D are block diagrams for explaining the enhancement unit 200 exemplarily illustrated in FIG. 2. FIGS. 4A and 4B respectively illustrate a motion adaptive enhancement unit 240 and a motion adaptive filtering unit 210 illustrated in FIGS. 3A through 3D.

FIG. 3A exemplarily illustrates a case where the enhancement unit 200 consists of a motion adaptive enhancement unit 240, and FIG. 3B exemplarily illustrates a case where the enhancement unit 200 consists of a filtering unit 230 and a motion adaptive enhancement unit 240.

Referring to FIGS. 3A and 3B, the motion adaptive enhancement unit 240 adaptively applies a detail enhancement level to an image according to a degree of motion of the image, when image enhancement is performed. At the time of image enhancement, no image enhancement is applied to an area of high motion in the image, in order to prevent noise included in the area of high motion from being emphasized due to detail enhancement and thereby avoid image deterioration.

Before the motion adaptive enhancement unit 240 applies image detail enhancement according to a degree of motion, an input image can be low-pass filtered by the filtering unit 230. By performing low-pass filtering on areas with motion in an input image, it is possible to relieve image noise existing on the areas with motion in the input image and prevent noise from being emphasized when the motion adaptive enhancement unit 240 performs image enhancement.

FIG. 4A exemplarily illustrates the motion adaptive enhancement unit 240.

Referring to FIG. 4A, the motion adaptive enhancement unit 240 includes a high-pass filter 241, a first multiplier 242, a second multiplier 243, and a first adder 244.

Sine a sharp change in the corners and brightness of an input image relates to a high frequency component, high-pass filtering for attenuating a low frequency component without causing disturbance in a high frequency component is performed to emphasize the details and clearness of the image. If the filtering unit 230 is not disposed in front of the motion adaptive enhancement unit 240, as illustrated in FIG. 3A, an input image is input to the high-pass filter 241. If the filtering unit 230 is disposed in front of the motion adaptive enhancement unit 240, as illustrated in FIG. 3B, an input image subjected to low-pass filtering to relieve noise is input to the high-pass filter 241.

The second multiplier 243 multiplies an image not filtered by the high-pass filter 241 by a degree of motion a estimated by the motion estimation unit 100. The first multiplier 242 multiplies the image filtered by the high-pass filter 241 by a value ‘1 -α’ resulting from subtracting the degree of motion α from ‘1’. The first adder 244 adds the output value of the first multiplier 242 with the output value of the second multiplier 243. That is, weights based on the degree of motion are respectively added to an image subjected to high-pass filtering and an image not subjected to high-pass filtering, and the resultant values are summed.

Accordingly, image enhancement is applied to an area without motion in the input image while no image enhancement is applied to an area with motion in the image. The output value of the motion adaptive enhancement unit 240 can be expressed by the following Equation 1.
y(n,m)=α·x′(n,m)+(1-α)·HPF{x′(n,m)} Equation 1
where, 0≦α≦1

In Equation 1, y(n, m) represents the output value of the motion adaptive enhancement unit 240, x′(n,m) represents an input image or an image low-pass filtered by the filtering unit 230, which is an input value of the motion adaptive enhancement unit 240, (n, m) is the location of a pixel, α represents a degree of motion estimated by the motion estimation unit 100, and HPF{ x′(n,m) } represents a value obtained by high-pass filtering the input value of the motion adaptive enhancement unit 240.

Meanwhile, FIG. 3C exemplarily illustrates a case where the enhancement unit 200 illustrated in FIG. 2 consists of a motion adaptive filtering unit 210 and an image enhancement unit 220, and FIG. 3D exemplarily illustrates a case where the enhancement unit 200 consists of the motion adaptive filtering unit 210 and the motion adaptive enhancement unit 240.

That is, FIG. 3C shows a case where a degree of motion calculated by the motion estimation unit 100 is used for filtering and is not used for image enhancement. FIG. 3D shows a case where the degree of motion is used for both filtering and image enhancement.

Referring to FIGS. 3C and 3D, the motion adaptive filtering unit 210 adaptively applies a low-pass filtering level according to a degree of motion of an image. Low-pass filtering is applied to an area of high motion in an image, so that noise included in the area of high motion is removed. Then, by performing signal processing such as detail enhancement, clearness enhancement, etc., in the following devices, it is possible to prevent image noise from being emphasized.

FIG. 4B exemplarily illustrates the motion adaptive filtering unit 210.

Referring to FIG. 4B, the motion adaptive filtering unit 210 includes a low-pass filter 211, a third multiplier 212, a fourth multiplier 213, and a second adder 214.

In order to apply low-pass filtering to an area with motion and not apply low-pass filtering to an area without motion, weights based on the degree of motion are respectively added to an image subjected to low-pass filtering and an image not subjected to low-pass filtering.

Relatively, more values subjected to low-pass filtering are applied to an area of high motion in an input image, and relatively more values not subjected to low-pass filtering is applied to an area of low motion. Accordingly, noise generated by compressing, de-interlacing, etc. can be removed from the area of high motion.

Therefore, motion adaptive low-pass filtering for reducing image noise can be expressed by the following Equation 2.
y(n,m)=α·LPF{x(n, m)}+(1−α)·x(n,m) Equation 2
where, 0≦α≦1

In Equation 2, y(n, m) represents an output value of the motion adaptive filtering unit 210, x(n, m) represents an input image which is an input value of the motion adaptive filtering unit 210, (n, m) represents the location of a pixel, α represents a degree of motion estimated by the motion estimation unit 100, and LPF{x′(n,m) } represents an input value of the motion adaptive filtering unit 210, filtered by the low-pass filter 211.

As seen in Equation 2, the fourth multiplier 213 multiplies an image not subjected to low-pass filtering by the low-pass filter 211 by a degree of motion α estimated by the motion estimation unit 100. The third multiplier 212 multiplies an image subjected to low-pass filtering by the low-pass filter 211 by a value 1−α resulting from subtracting the degree of motion α from ‘1’. Then, the second adder 214 adds the output value of the third multiplier 212 with the output value of the fourth multiplier 213.

As exemplarily illustrated in FIGS. 3C and 3D, after an image is low-pass filtered according to a degree of motion in the motion adaptive filtering unit 210, the details, clearness, etc. of the image are improved by the image enhancement unit 220 or the motion adaptive enhancement unit 240. As described above with reference to FIG. 4A, the motion adaptive enhancement unit 240 adaptively enhances the details, clearness, etc. of the image low-pass filtered according to a degree of motion. Meanwhile, the image enhancement unit 220 enhances details of an image subjected to motion-adaptive low-pass filtering, without considering the degree of motion estimated by the motion estimation unit 100.

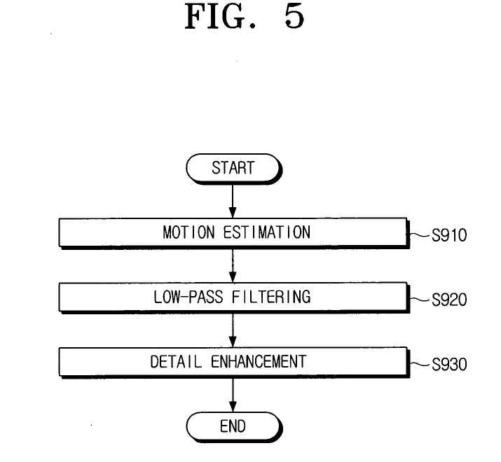

FIG. 5 is a flowchart illustrating an image enhancement method using motion estimation according to an exemplary embodiment of the present invention.

Referring to FIG. 5, motion estimation is performed using temporally successive input images (operation S910). Then, the most similar block between an image whose details, clearness, etc. will be improved and a temporally successive image is estimated, and a degree of motion of the estimated block is detected. Here, a motion estimation value which represents the degree of motion is an arbitrary value between ‘0’ and ‘1’. The motion estimation value is used as a weight when details, clearness, etc. of an image are enhanced or when noise is removed.

Subsequently, in order to remove noise included in the input image, low-pass filtering is performed on the input image (operation S920). The input image can include noise, due to compressing or deinterlacing for transforming interlaced images into progressive images. The image noise is significant in an area of high motion in the image. Accordingly, when detail emphasis and clearness enhancement are performed on an image with noise, it is desirable to prevent the image noise from being emphasized. By smoothing the input image with noise, the image noise can be removed.

When low-pass filtering is performed to smooth the input image, an adaptively estimated degree of motion can be used. The degree of motion is used when low-pass filtering is performed, in such a manner that a first value obtained by multiplying an input image subjected to low-pass filtering by the estimated motion degree and a second value obtained by multiplying an input image not subjected to low-pass filtering by a value resulting from subtracting the motion degree from 1 are summed.

Accordingly, more low-pass filtered values are applied to an area of high motion in the input image, and less low-pass filtered values are applied to an area of low motion in the input image.

Subsequently, detail emphasis, clearness enhancement, etc. are performed on the image so that the image is enhanced (operation S930). Then, high-pass filtering for image enhancement is performed on the input image without noise subjected to low-pass filtering, using the adaptively estimated degree of motion. In order to emphasize fine and detailed parts in the image or to improve errors or blurred parts appearing when the image is captured using a specific method, an enhancement level is adaptively applied to the image according to a degree of motion of the image. If the degree of motion is applied when the low-pass filtering is performed, the degree of motion cannot be applied when the image enhancement is performed. Then, by summing a third value obtained by multiplying the image subjected to high-pass filtering by the estimated degree of motion, and a fourth value obtained by multiplying the input image not subjected to high-pass filtering by a value resulting from subtracting the degree of motion from ‘1’, motion information can be used when the high-pass filtering is performed.

Accordingly, since the image enhancement is applied relatively less to the area of high motion in the input image, and the image enhancement is applied relatively more to the area of low motion in the input image, it is possible to prevent image noise from being emphasized when the image is enhanced. Meanwhile, in order to relieve noise prior to image enhancement processing, the low-pass filtering can be selectively performed, and the motion information can be selectively used when the low-pass filtering is performed or when the image enhancement is performed.

As such, by applying low-pass filtering to an area with motion in an input image without applying image enhancement such as detail emphasis, clearness enhancement, etc., it is possible to prevent image noise from being generated in the area with motion.

As described above, according to exemplary embodiments the present invention, by applying image enhancement to an area without motion in an input image while not applying the image enhancement to an area with motion in the input image, it is possible to prevent image noise from being generated in the area with motion in the input image.

The foregoing embodiments and advantages are merely exemplary in nature and are not to be construed as limiting the present invention. The present teaching can be readily applied to other types of embodiments. Also, the description of the exemplary embodiments of the present invention is intended to be illustrative, and therefore it does not limit the scope of the claims. Alternatives, modifications, and variations of the exemplary embodiments described herein will be readily apparent to those skilled in the art.

What is claimed is:

1. An image enhancement apparatus comprising:
a motion estimation unit which estimates a degree of motion between an input image which is subjected to an image enhancement and a temporally successive image; and
an enhancement unit which applies the image enhancement to an area without motion in the input image, while not applying the image enhancement to an area with motion in the input image, on the basis of the degree of motion.

2. The image enhancement apparatus of claim 1, wherein the enhancement unit comprises:
a high-pass filter which high-pass filters the input image;
a first multiplier which multiplies the input image which is high-pass filtered by a value resulting from subtracting the degree of motion from ‘1’;
a second multiplier which multiplies the input image by the degree of motion; and
a first adder which adds a multiplied result received from the first multiplier with a multiplied result received from the second multiplier.

3. The image enhancement apparatus of claim 1, further comprising a filtering unit which smoothes the input image prior to the image enhancement being applied by the enhancement unit.

4. The image enhancement apparatus of claim 3, wherein the filtering unit smoothes the area with motion in the input image, and does not smooth the area without motion in the input image, on the basis of the degree of motion.

5. The image enhancement apparatus of claim 4, wherein the filtering unit comprises:
a low-pass filter which low-pass filters the input image;
a third multiplier which multiplies the input image which is low-pass filtered by the degree of motion;
a fourth multiplier which multiplies the input image by a value resulting from subtracting the degree of motion from ‘1’; and
a second adder which adds a multiplied result received from the third multiplier with a multiplied result received from the fourth multiplier.

6. An image enhancement method comprising:
estimating a degree of motion between an input image which is subjected to an image enhancement and a temporally successive image; and
applying the image enhancement to an area without motion in the input image, while not applying the image enhancement to an area with motion in the input image, on the basis of the degree of motion.

7. The image enhancement method of claim 6, wherein the applying the image enhancement comprises:
high-pass filtering the input image;
multiplying the input image which is high-pass filtered by a value resulting from subtracting the degree of motion from ‘1’, thereby obtaining a first output value;
multiplying the input image by the degree of motion, thereby obtaining a second output value; and
summing the first output value and the second output value.

8. The image enhancement method of claim 6, further comprising smoothing the input image to remove noise of the input image prior to the applying the image enhancement.

9. The image enhancement method of claim 8, wherein the smoothing the input image to remove noise is performed on the area with motion in the input image and the smoothing the input image is not performed on the area without motion in the input image, on the basis of the degree of motion.

10. The image enhancement method of claim 9, wherein the smoothing the input image to remove noise comprises:
performing low-pass filtering on the input image;
multiplying the input image subjected to low-pass filtering by the degree of motion, to obtain a third output value;
multiplying the input image by a value resulting from subtracting the degree of motion from ‘1’, to obtain a fourth output value; and
summing the third output value with the fourth output value.
